(19) United States
(12) Patent Application Publication
(10) Pub. No.: US 2025/0162685 A1
(43) Pub. Date: May 22, 2025

(54) ELECTRIC TRICYCLE AND CARRIER

(71) Applicant: Leon P.T. Nguyen, Independence, MO (US)

(72) Inventor: Leon P.T. Nguyen, Independence, MO (US)

(21) Appl. No.: 18/951,256

(22) Filed: Nov. 18, 2024

Related U.S. Application Data
(60) Provisional application No. 63/600,454, filed on Nov. 17, 2023.

(51) Int. Cl. B62M 6/70; B62J 43/13; B62K 5/05; B62M 9/00

(52) U.S. Cl. CPC B62M 6/70; B62J 43/13; B62K 5/05; B62M 9/00

(57) ABSTRACT

An electric tricycle includes a frame with a longitudinal member, a transverse axle member and a seat subframe. Front, steerable guide wheels are mounted on opposite sides of the transverse axle member and are linked to a transverse, steering handlebar linkage with handgrips. The seat subframe mounts a seat for the occupant. A hybrid drive system includes a pedal-chain-sprocket drive for driving a rear wheel and electric drive engaging the chain.

### CROSS-REFERENCE TO RELATED APPLICATION

This application claims priority in U.S. Provisional Patent Application No. 63/600,454, filed on Nov. 17, 2023, which is incorporated herein by reference.

### BACKGROUND OF THE INVENTION

### 1. Field of the Invention

The present invention relates generally to electric vehicles (EVs), and more specifically to an electric tricycle and carrier.

### 2. Description of the Related Art

Electric vehicles (EVs) are commercially available in a wide variety of sizes and configurations. For example, electric golf carts have long been available and offer the advantages of quiet operation without expending fossil fuels. They are particularly well-suited for frequent starts and stops, as encountered in playing golf.

Full-size, street-legal EVs have recently grown in popularity and currently account for a significant portion of the new vehicle market. Unlike conventional vehicle with internal combustion engines, they avoid the environmental problems associated with the emissions from internal combustion engines.

Heretofore there has not been available an electric tricycle, the advantages and features of the present invention. These advantages include practically zero emissions, quiet operation, efficiency and the availability of recharging on the existing power grid. The single-seat configuration of the electric tricycle accommodates most of the transportation needs of many individuals. The electric tricycle can also be employed for transporting relatively small loads, e.g., for delivery trips. Still further, the electric tricycle can be transported on a carrier configured for mounting on an automobile.

Heretofore there has not been available a system or method for an electric tricycle with the advantages and features of the present invention.

### BRIEF SUMMARY OF THE INVENTION

The present invention generally provides an electric tricycle with multiple levels of pedal assistance via the electric motor and solar charging capabilities. The electric tricycle can be easily transported via a carrier or rack configured for attachment to an automobile. The electric tricycle of the present invention is a three-wheeled vehicle that is propelled by an electric motor and/or foot pedals via a drive chain. It combines the stability and balance of a tricycle with the convenience and eco-friendliness of electric power.

### BRIEF DESCRIPTION OF THE DRAWINGS

The drawings constitute a part of this specification and include exemplary embodiments of the present invention illustrating various objects and features thereof.

FIG. 1 is an upper, front, left side view of an electric tricycle embodying an aspect of the present invention, shown mounted on a carrier rack attached to an automobile.

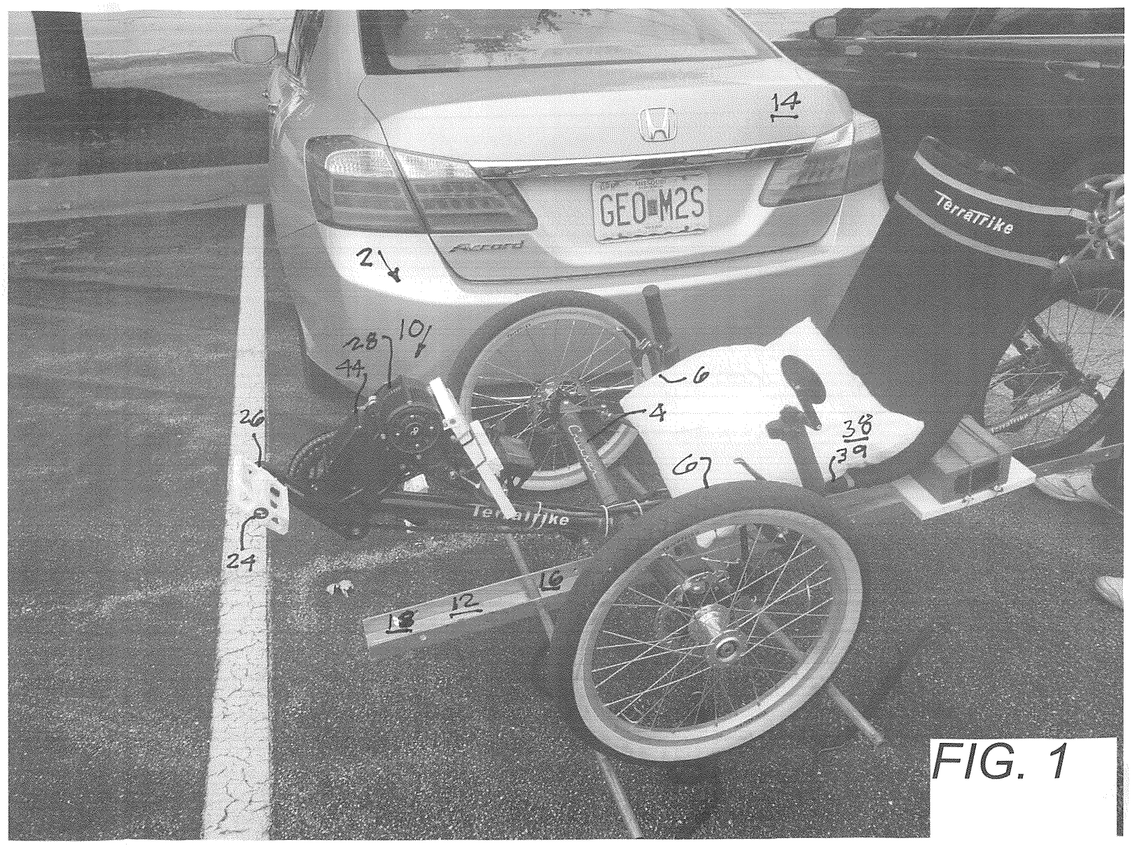

FIG. 2 is an upper, front, right side view of the electric tricycle. Photograph of the preferred embodiment of the invention.

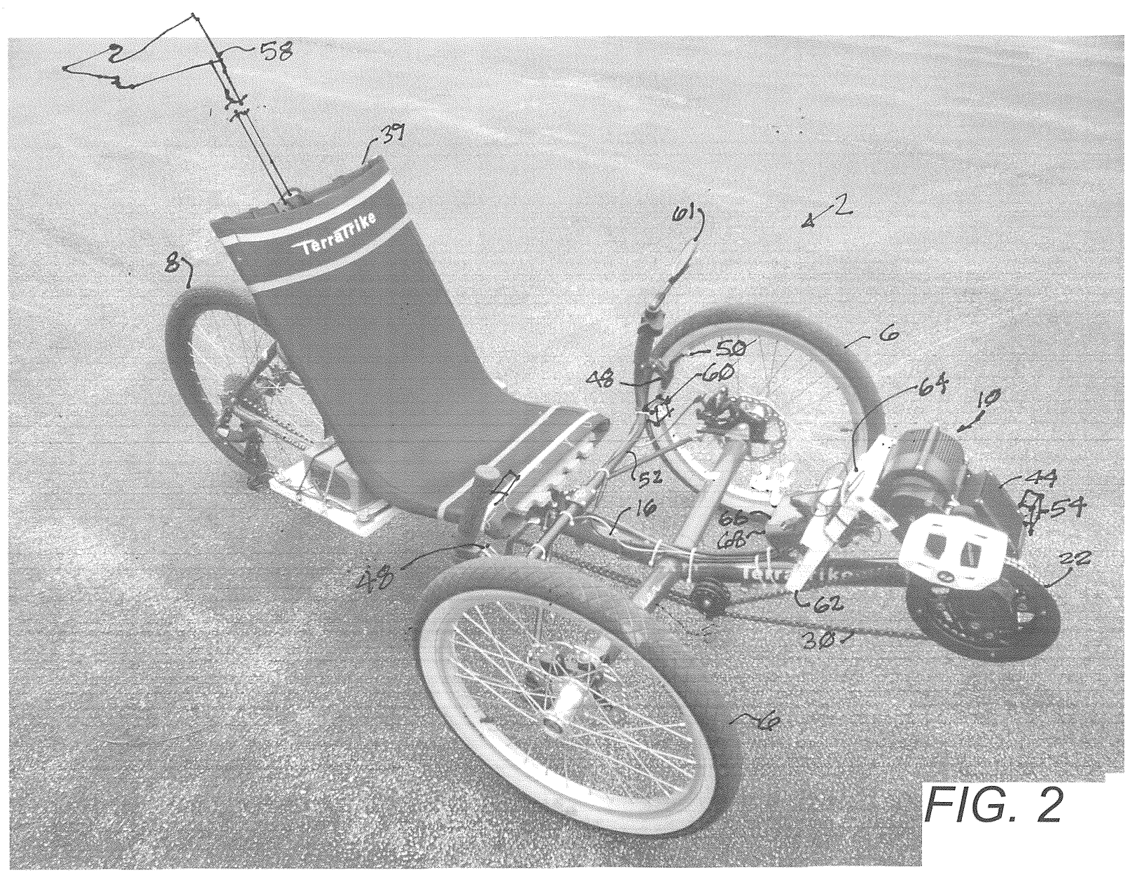

FIG. 3 is an upper, rear, left side view multiple preferred embodiments of the invention.

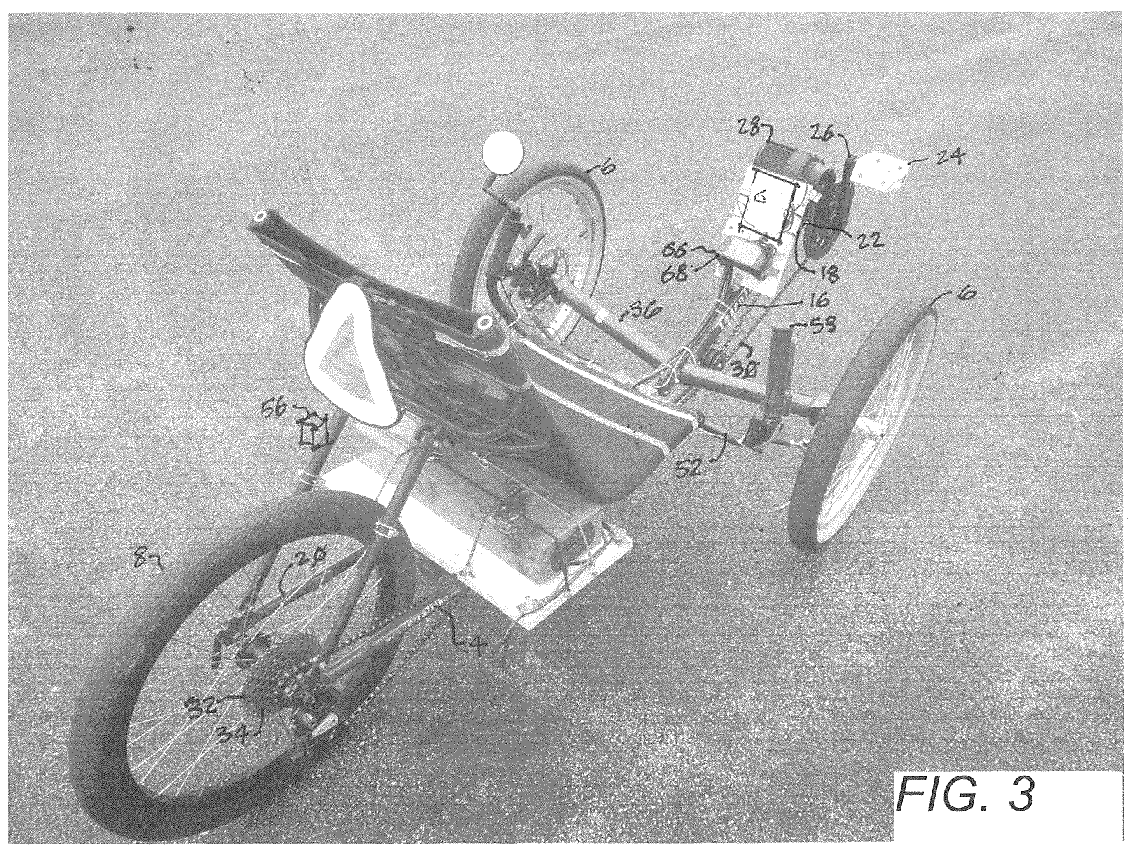

FIG. 4 is an upper, rear view of the carrier, shown mounted on the receiver hitch of an automobile.

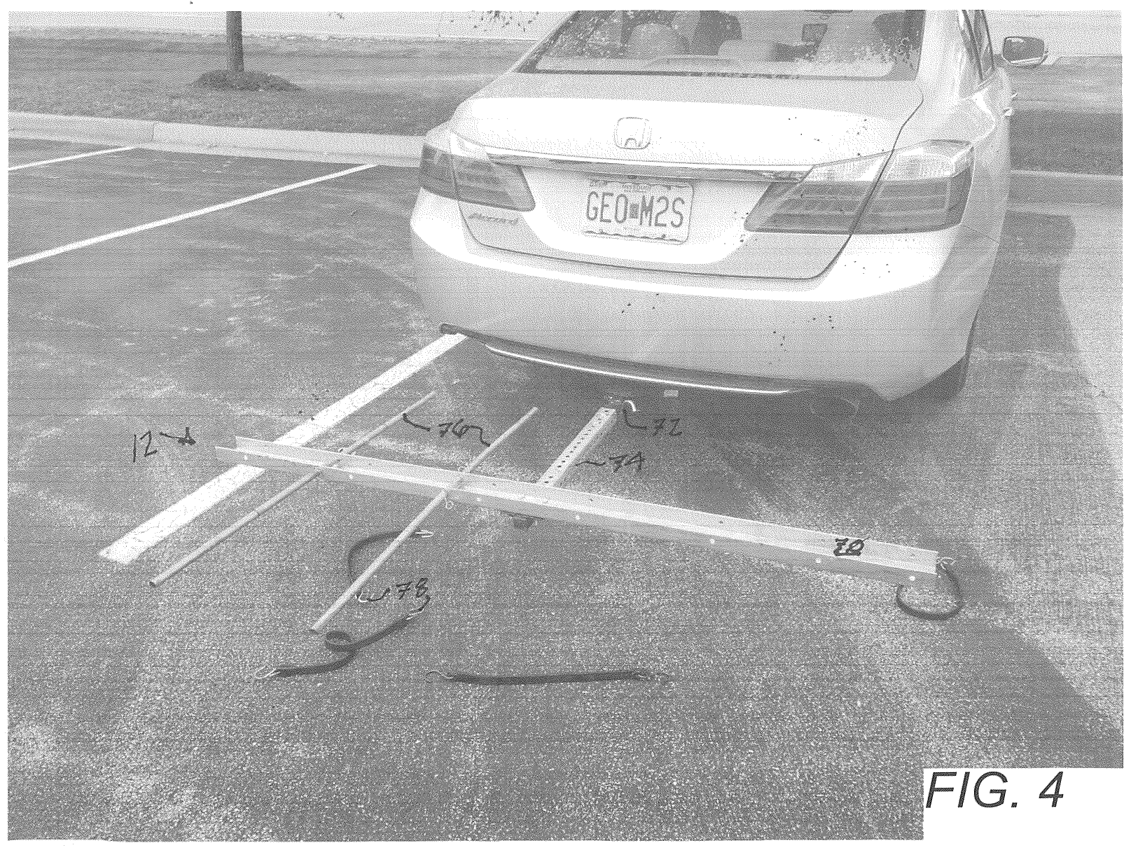

FIG. 5 is an upper, left side view of a rear wheel and frame rear end of the electric tricycle, shown with a rear wheel secured in a transverse channel of the carrier by a bungee cord.

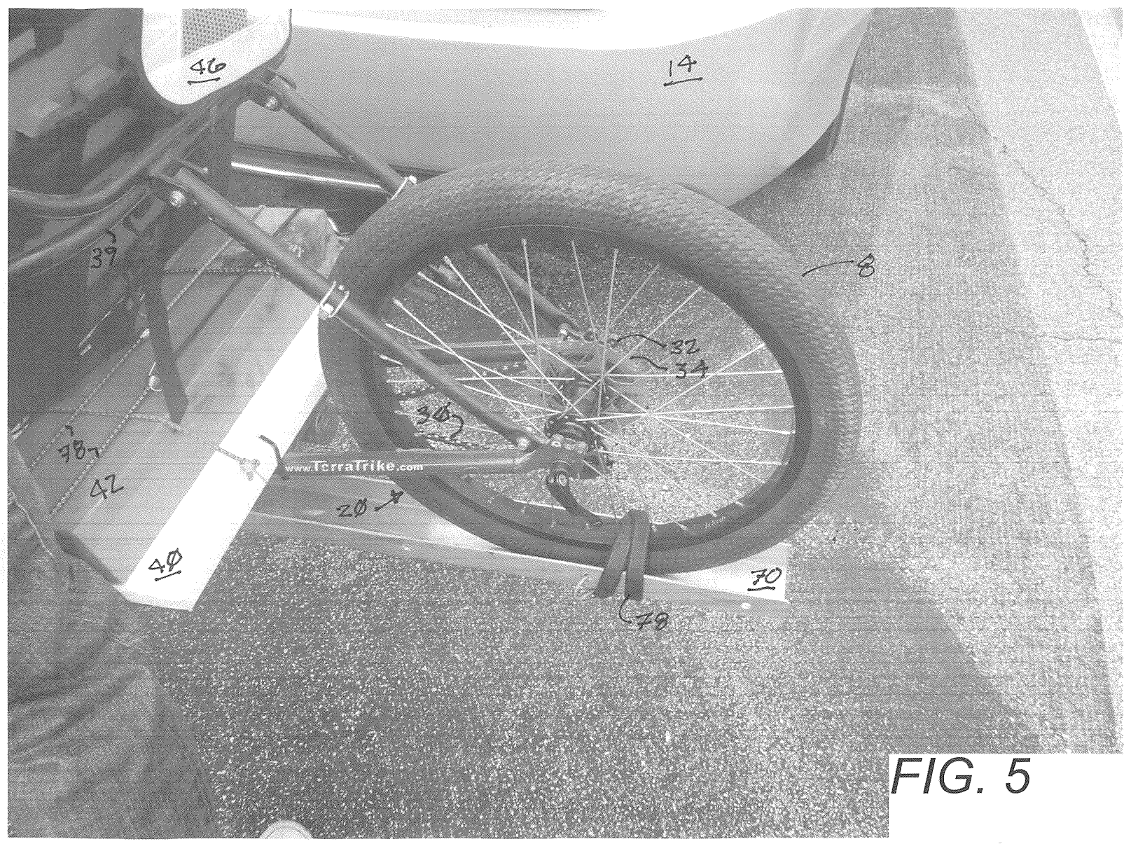

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Electric Tricycle 2

An electric tricycle 2 embodying an aspect of the present invention generally includes: a frame 4 mounting a pair of front wheels 6 and a rear drive wheel 8; and a hybrid drive system 10. A carrier rack 12 is configured for releasably mounting on an automobile 14 and transporting the electric tricycle 2.

The electric tricycle frame 4 includes a longitudinal frame member 16 extending fore-and-aft between a longitudinal frame front end 18 and a longitudinal frame back end 20. The frame front end 18 mounts a front sprocket 22 driven by a pair of foot pedals 24 mounted on a crank 26. A variable speed electric motor 28 is mounted on the frame front end 18 and engages a drive chain 30, which is also pedal-driven by the front sprocket 22.

The drive chain 30 extends along the longitudinal frame member 16 to the rear drive wheel 8, which includes a rear sprocket cassette 32 with individual sprockets 34 of varying diameters for adjusting the corresponding gear ratios. The hybrid drive system 10 provides more power in lower gears, thus enabling the electric tricycle 2 to ascend inclines on hills. Conversely, higher gears can achieve higher speeds.

The longitudinal frame member 16 mounts a transverse axle assembly 36, which mounts the front wheels 6. A seat 38 with a seat subframe 39 is mounted on the longitudinal frame member 16. A battery shelf 40 is mounted on the longitudinal frame member 16 behind the seat 38 and supports a rechargeable battery 42. Without limitation, a 72 V lithium-ion battery or batteries can be provided. A photovoltaic solar panel 44 on the longitudinal frame member front end 18 is connected to the battery 42 for recharging same. Additional solar panels can be placed at other locations on the electric tricycle 2. The battery 42 can also be recharged with conventional battery chargers. Multiple batteries 42 can be carried on the electric tricycle 2, e.g., on the battery shelf 40, for extending the range.

Safety features on the electric tricycle 2 include a safety reflector 46 on the back of the seat 38 and caliper brakes 48 on the front wheels 6 actuated by brake levers 50 on a transverse handlebar 52 with handgrips 53. A headlight 54 and a taillight 56 can be provided for nighttime visibility. A safety flag 58 can improve visibility of the relatively low electric tricycle 2, e.g., amongst other vehicles. An audible alarm 60 on the handlebar 52 can alert nearby motorists and pedestrians. A rearview mirror 61 is mounted on a handgrip 53.

The frame 4 mounts a panel 62 in front of the occupant, which can support a telecommunications device 64, such as an iPhone® or Android® device accessible to operator. The panel 62 can also support printed material, such as maps and directions, in the operator's field of vision for convenience in navigation. Other instruments and accessories can include a speedometer/odometer 66 and a battery charge indicator 68.

The carrier rack 12 includes transverse channel 70, which is connected to a receiver hitch 72 on the automobile 14 by a tubular member 74. A pair of rods 76 extends through the channel member 70 and receive the front wheels 6. The rear wheel 8 is received in the channel member 70. For transport with the automobile 14, the electric tricycle to be secured in place with elastic straps, e.g. bungee cords 78.

The electric tricycle 2 can be adapted from an existing tricycle. Without limitation, suitable tricycles are available from TerraTrike, 4460 40th St. SE, Grand Rapids, MI 49512 (www.terratrike.com).

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An electric tricycle, which includes:
a frame including a longitudinal frame member with front and back ends and a transverse axle assembly with opposite ends and fixedly connected to the longitudinal frame member;
a pair of front wheels each pivotally mounted on a respective axle assembly opposite end; each front wheel being rotatable relative to a vertical axis;
a seat assembly on the longitudinal frame member aft of the axle assembly including a seat section and a back section;
a rear, drive wheel mounted on the longitudinal frame member back end;
a hybrid drive system including a pedal drive subsystem and an electric drive subsystem;
said pedal drive including: a front sprocket connected to a crank having a pair of pedals each projecting laterally from crank side; a rear sprocket mounted on said frame longitudinal member rear end and drivingly connected to said rear wheel; and a drive chain engaging said front and rear sprockets; and
said electric drive subsystem including: an electric motor mounted on said longitudinal frame member front end and including a sprocket engaging said drive chain; a battery mounted on said frame and electrically connected to said motor; and a motor controller mounted on a respective handgrip and electrically connecting said battery and said motor.
